(19) United States
(12) Patent Application Publication
(10) Pub. No.: US 2026/0259925 A1
(43) Pub. Date: Sep. 3, 2026

(54) INFORMATION PROCESSING

(71) Applicants: Beijing Zitiao Network Technology Co., Ltd., Beijing (CN); Peking University, Beijing (CN)

(72) Inventors: Yifei Xia, Beijing (CN); Suhan Ling, Beijing (CN); Fangcheng Fu, Beijing (CN); Yujie Wang, Beijing (CN); Xuefeng Xiao, Beijing (CN); Huixia Li, Beijing (CN); Bin Cui, Beijing (CN)

(21) Appl. No.: 19/546,212

(22) Filed: Feb. 20, 2026

(30) Foreign Application Priority Data
Feb. 28, 2025 (CN) 202510238303.5

(51) Int. Cl. G06F 16/435

(52) U.S. Cl. CPC G06F 16/435

(57) ABSTRACT

According to the embodiments of the disclosure, a method, an apparatus, a device and a storage medium for information processing are provided. The method includes: obtaining input content of a diffusion model; determining a first attention matrix using an attention unit at a first denoising time step of the diffusion model; determining a plurality of target blocks from a plurality of candidate blocks based on weight information corresponding to the plurality of candidate blocks in the first attention matrix; determining a second attention matrix using the attention unit at a second denoising time step of the diffusion model based on an attention mask; and generating target content corresponding to the input content at least based on the second attention matrix.

### CROSS-REFERENCE

This application claims the priority to Chinese Patent Application No. 202510238303.5, filed on Feb. 28, 2025, and entitled “METHOD, APPARATUS, DEVICE AND STORAGE MEDIUM FOR INFORMATION PROCESSING”, the entirety of which is incorporated herein by reference.

### TECHNICAL FIELD

Example embodiments of the present disclosure generally relate to the field of computers, and in particular, to information processing.

### BACKGROUND

With the development of computer technology, diffusion models may be used to process input content of various modalities, and attention mechanisms may be used to improve the accuracy of output results. However, in the case of excessive or complex content of the input content, the processing efficiency of diffusion models is low, and therefore more optimized diffusion models are required to improve the overall efficiency of the models.

### SUMMARY

In a first aspect of the present disclosure, a method of information processing is provided. The method includes: obtaining input content of a diffusion model, the diffusion model including a transformer unit, and the transformer unit including an attention unit; determining, using the attention unit and at a first denoising time step of the diffusion model, a first attention matrix of a first query feature and a first key feature, the first attention matrix corresponding to full attention; determining, based on weight information corresponding to a plurality of candidate blocks in the first attention matrix, a plurality of target blocks from the plurality of candidate blocks; determining, using the attention unit and at a second denoising time step of the diffusion model, a second attention matrix of a second query feature and a second key feature based on an attention mask, the attention mask being determined based on the plurality of target blocks; and generating target content corresponding to the input content at least based on the second attention matrix.

In a second aspect of the present disclosure, an apparatus for information processing is provided. The apparatus includes: an obtaining module configured to obtain input content of a diffusion model, the diffusion model including a transformer unit, and the transformer unit including an attention unit; a first determination module configured to determine, using the attention unit and at a first denoising time step of the diffusion model, a first attention matrix of a first query feature and a first key feature, the first attention matrix corresponding to full attention; a second determination module configured to determine, based on weight information corresponding to a plurality of candidate blocks in the first attention matrix, a plurality of target blocks from the plurality of candidate blocks; a third determination module configured to determine, using the attention unit and at a second denoising time step of the diffusion model, a second attention matrix of a second query feature and a second key feature based on an attention mask, the attention mask being determined based on the plurality of target blocks; and a generation module configured to generate target content corresponding to the input content at least based on the second attention matrix.

In a third aspect of the present disclosure, an electronic device is provided. The device includes at least one processor; and at least one memory coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium has a computer program stored thereon, wherein the computer program is executable by a processor to implement the method of the first aspect.

In a fifth aspect of the present disclosure, a computer program product is provided. The computer program product includes computer-executable instructions that, when executed by a processor, implement the method according to the first aspect of the present disclosure.

It should be understood that content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The foregoing and other features, advantages, and aspects of the embodiments of the present disclosure become more apparent with reference to the following detailed description and in conjunction with the drawings. In the drawings, the same or similar reference numerals denote the same or similar elements, wherein:

FIG. 1 is a schematic diagram of an example environment in which the embodiments of the present disclosure may be implemented;

FIG. 2 is a flowchart of a process of information processing according to some embodiments of the present disclosure;

FIG. 3 is a schematic diagram of a full attention mechanism according to some embodiments of the present disclosure;

FIG. 4 is a schematic diagram of an attention mask according to some embodiments of the present disclosure;

FIG. 5 is a flowchart of information processing in a diffusion model according to some embodiments of the present disclosure;

FIG. 6 is a schematic structural block diagram of an apparatus for information processing according to some embodiments of the present disclosure;

FIG. 7 is a block diagram of an electronic device capable of implementing a plurality of embodiments of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms, and should not be interpreted as limited to the embodiments set forth herein. Instead, these embodiments are provided for more thorough and complete understanding of the present disclosure. It should be understood that the drawings and embodiments of the present disclosure are only for illustrative purposes, and are not intended to limit the protection scope of the present disclosure.

It should be noted that the titles of any sections/subsections provided herein are not restrictive. Various embodiments are described throughout this paper, and any type of embodiment may be included under any section/subsection. In addition, the embodiments described in any section/subsection may be combined with any other embodiments described in the same section/subsection and/or different sections/subsections in any way.

In the description of the embodiments of the present disclosure, the term “include/comprise” and similar terms thereof should be understood as open-ended inclusion, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may be included below. The terms “first”, “second”, etc. may refer to different or same objects. Other explicit and implicit definitions may be included below.

The embodiments of the present disclosure may involve user data, data acquisition and/or data use, etc. These aspects all follow the corresponding laws, regulations, and related provisions. In the embodiments of the present disclosure, all data collection, acquisition, processing, forwarding, and use are carried out on the premise that the user knows and confirms. Accordingly, when implementing the embodiments of the present disclosure, it is necessary to inform the user of the possible involved data or data types, use ranges, use scenarios, etc. and obtain the user's authorization in an appropriate manner according to relevant laws and regulations. The specific informing and/or authorization manner may change according to the actual situation and application scenarios, and the scope of the present disclosure is not limited in this regard.

If the schemes in this specification and the embodiments involve personal information processing, the processing is carried out on the premise that there is a legal basis (for example, the consent of the personal data subject is obtained, or it is necessary to perform a contract, etc.), and the processing is only carried out within the specified or agreed scope. If the user refuses to process personal data other than the necessary data required for the basic functions, it will not affect the user's use of the basic functions.

Traditionally, a diffusion model is a content diffusion model that generates new samples by simulating a process of data gradually transforming from noise to a target distribution. A core idea of the diffusion model is to transform data distribution into simple distribution by gradually adding noise, and then recover data from the noise through a reverse process. Since the application of an attention mechanism in the diffusion model enables various generation tasks to be completed more accurately, the attention mechanism is widely used in the diffusion model. However, if the input content of the diffusion model is too large or too complex, for example, the input content is a long video, the calculation cost of the diffusion model will increase with the improvement of the video resolution or the increase of the video duration, resulting in low processing efficiency.

The embodiments of the present disclosure provide a solution of information processing. According to the solution, input content of a diffusion model is obtained, wherein the diffusion model includes a transformer unit, and the transformer unit includes an attention unit. A first attention matrix of a first query feature and a first key feature is determined using the attention unit at a first denoising time step of the diffusion model, wherein the first attention matrix corresponds to full attention. A plurality of target blocks are determined from a plurality of candidate blocks based on weight information corresponding to the plurality of candidate blocks in the first attention matrix. A second attention matrix of a second query feature and a second key feature is determined using the attention unit at a second denoising time step of the diffusion model based on an attention mask, where the attention mask is determined based on the plurality of target blocks. Further, target content corresponding to the input content is generated at least based on the second attention matrix.

Based on this approach, the embodiments of the present disclosure may reuse the attention mask generated in the previous denoising time step in other denoising time steps of the diffusion model, so that the diffusion model may improve the processing efficiency of the overall model while maintaining the quality of the output result.

### Example Environment

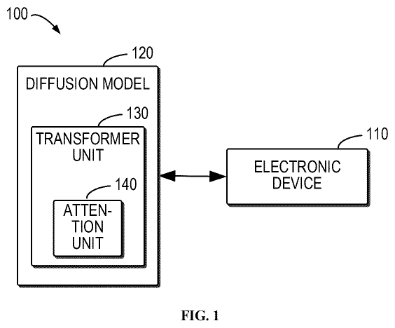

FIG. 1 is a schematic diagram of an example environment 100 in which the embodiments of the present disclosure may be implemented. As shown in FIG. 1, the example environment 100 may include an electronic device 110.

In some embodiments, the electronic device 110 may: obtain input content of a diffusion model 120, the diffusion model 120 including a transformer unit 130, and the transformer unit 130 including an attention unit 140; determine a first attention matrix of a first query feature and a first key feature using the attention unit 140 at a first denoising time step of the diffusion model 120, the first attention matrix corresponding to full attention; determine a plurality of target blocks from a plurality of candidate blocks based on weight information corresponding to the plurality of candidate blocks in the first attention matrix; determine a second attention matrix of a second query feature and a second key feature using the attention unit 140 at a second denoising time step of the diffusion model based on an attention mask, the attention mask being determined based on the plurality of target blocks; and generate target content corresponding to the input content at least based on the second attention matrix. The diffusion model 120 may be deployed on the electronic device 110, or may be deployed on other devices, which will not be repeated here.

In some embodiments, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a TV receiver, a radio broadcast receiver, an e-book device, a game device, or any combination thereof, including the accessories and peripherals of these devices, or any combination thereof. In some embodiments, the electronic device 110 may also support any type of interface for a target user (such as a “wearable” circuit, etc.).

The electronic device 110 may also be an independent physical server, a server cluster or distributed system composed of multiple physical servers, or may provide cloud services, cloud databases, cloud computing, cloud functions, cloud storage, network services, cloud communications, middleware services, domain name services, security services, content delivery networks, and basic cloud computing services such as big data and artificial intelligence platforms. The electronic device 110 may, for example, include a computing system/server, such as a mainframe, an edge computing node, a computing device in a cloud environment, etc.

It should be understood that the structures and functions of various elements in the environment 100 are described for illustrative purposes only, without suggesting any limitation on the scope of the present disclosure.

Some example embodiments of the present disclosure will be described below with continued reference to the drawings.

### Example Process

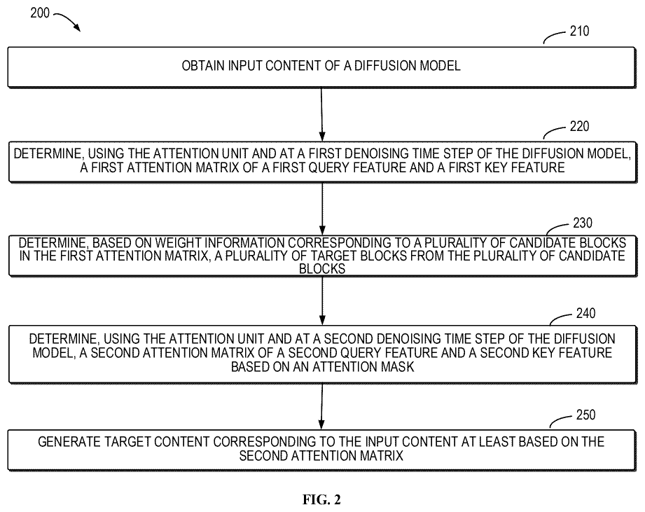

FIG. 2 is a flowchart of a process 200 of information processing according to some embodiments of the present disclosure. The process 200 may be implemented at the electronic device 110. The process 200 is described below with reference to FIG. 1.

At block 210, the electronic device may obtain input content of a diffusion model.

In some embodiments, the input content may be any form of content that may be input into the diffusion model for information processing. The input content may include content of one modality or content of multiple modalities. For example, the input content may be text content in natural language processing, image content in computer vision, or the like. The input content may also include a combination of multiple modalities such as text and video, image and video, etc., which will not be repeated here.

In some embodiments, the diffusion model is a network model that generates a target result by simulating a process of data gradually transforming from noise to a target distribution. A core idea of the diffusion model is to transform data distribution into simple distribution by gradually adding noise, and then recover data from the noise through a reverse process. For example, the diffusion model may implement tasks such as text-to-image synthesis, realistic video generation, and three-dimensional content creation.

In some embodiments, in order to enhance the extraction efficiency of the diffusion model for important features, so that the diffusion model may automatically focus on key features or regions in the input content, an attention mechanism may be applied in the diffusion model in the embodiments of the present application. The attention mechanism is a deep learning technology that simulates human attention allocation. It allows the model to dynamically focus on key parts and ignore unimportant information when processing input data. A core idea of this mechanism is to assign different weights to different parts of the input data by calculating the correlation between the different parts and a current task, so as to extract key information more effectively.

In some embodiments, the diffusion model may include a transformer unit, and the transformer unit may include an attention unit. For example, the diffusion model may be a DiT (diffusion transformer) model. The DiT model may optimize prediction through the diffusion process, and process multimodal data such as video and text by using the attention mechanism. The spatial, temporal, and cross-modal dependencies may be captured with attention mechanism.

At block 220, the electronic device 110 determines, using the attention unit and at a first denoising time step of the diffusion model, a first attention matrix of a first query feature and a first key feature.

The diffusion model transforms data distribution into simple distribution by gradually adding noise, and then recovers data from the noise through the reverse process, thus multiple denoising time steps are experienced in the process of content generation using the diffusion model. In the embodiments of the present application, the first denoising time step is used as an example. For example, the electronic device 110 may input the input content into the diffusion model, and then perform data preprocessing on the input content, for example, perform operations such as normalization, feature extraction, and dimension transformation on the input content, so as to transform the input data into a format suitable for subsequent attention calculation, and obtain a first feature sequence.

In some embodiments, since the input content may include more than one modality, in order to improve the fusion performance among different modalities, a three-dimensional full attention mechanism may be used to calculate the first attention matrix. The three-dimensional full attention mechanism is an attention mechanism used to process content generation tasks. It captures global dependencies in spatial and temporal dimensions by transforming the input content into a sequence and applying self-attention across the entire sequence.

For example, FIG. 3 shows the working principle of the three-dimensional full attention mechanism in the DiT. The input content includes a video and a text. After the input content is transformed into the first feature sequence, the first feature sequence includes a first video frame sequence 310, a second video frame sequence 320, and a text sequence 330. Then, a query feature 350 and a key feature 340 may be obtained based on the first feature sequence. Further then, the first attention matrix 360 is constructed through the full attention mechanism. The number of frames in the video may be defined as f, the spatial resolution of each frame is h×w, t is the length of the text sequence, and f·h·w>>t. The total sequence length L corresponding to the input content is as follows:

$$L = f \cdot h \cdot w + t$$

In some embodiments, a multi-head attention mechanism may also be used in the diffusion model. The multi-head attention mechanism enables the model to simultaneously focus on different feature subspaces of the input content through parallel and independent attention mechanisms, thereby enabling the model to have the capability of multi-dimensional feature learning. For example, the first feature sequence may be linearly transformed to obtain the query feature Q, the key feature K, and a value feature V, Q, K, V∈R^{H×L×D}, where the query feature represents content that needs attention currently, the key feature represents a feature of each element in the first feature sequence, the value feature represents actual content of each element, where H is the number of attention heads, L is the length of the first feature sequence, and D is the number of dimensions of each attention head. Then, the similarity between the query feature and the key feature is calculated to obtain a score matrix. Then, in order to avoid the problem of gradient disappearance or explosion caused by an excessively large dot product result, the score matrix may further be scaled. Then, the scaled score is normalized by a softmax function to obtain the first attention matrix Wₐₜₜₙ∈R^{L×L}, which represents attention weights. A calculation formula corresponding to the first attention matrix may be as follows:

$${W}_{a t t n} = softmax ( \frac{Q {K}^{T}}{\sqrt{d}} )$$

At block 230, the electronic device 110 determines, based on weight information corresponding to a plurality of candidate blocks in the first attention matrix, a plurality of target blocks from the plurality of candidate blocks.

In some embodiments, the application of attention mechanism in the diffusion model requires a large amount of computation, especially for long videos. Therefore, the generation of high-fidelity long videos is usually limited by significant latency. For example, the first attention matrix is a matrix with the size of L×L, which will lead to a time and memory complexity of O(L²), and the calculation cost will increase with the improvement of the video resolution or the increase of the video duration, which is very unfriendly to the input content with a large amount of content.

In order to solve the problems of high computational complexity and a large amount of redundancy involved in the attention mechanism when processing long sequences, a sparse attention mechanism may be adopted in the attention module. The sparse attention mechanism may limit the scope or mode of attention calculation, so that the model may greatly reduce the calculation cost, process long sequence data more efficiently, and at the same time maintain or improve performance.

In some embodiments, the attention mask is commonly used to control the update of parameters in the neural network or filter specific elements in a tensor. It is implemented by introducing a binary mask matrix, in which most elements are zeros and only a few positions are non-zero values. In the embodiments of the present application, the attention mask indicates that the plurality of target blocks in the plurality of candidate blocks are retained to perform an attention operation. For example, in the attention mechanism, the attention mask may be used to represent which interactions between elements may be omitted and which interactions between elements need to be retained, so as to reduce the computational load. For example, interactions with small weights may be ignored to reduce the computational complexity, which not only ensures the model performance, but also greatly improves the model efficiency.

In some embodiments, there are multiple sparse patterns for the sparse attention mechanism. However, the sparsity of the diffusion model DiT will change considerably according to the input content, which makes the sparse pattern of offline search for DiT lack good portability and accuracy. In addition, since the sparse indices in DiT are very complex and the key areas are scattered, not concentrated and continuous, the sparse pattern of approximate search for DiT cannot accurately estimate the sparse indices in DiT.

In addition, the sparse attention mechanism of the diffusion model DiT will show significant hierarchical features within a modality and among different modalities. For example, due to the significant difference in interactions between video frames, the global attention weights present an obvious block-like feature based on frames, and the interactions between different frame blocks are significantly different, with a stronger aggregation trend within a specific frame block. Therefore, the diffusion model may be well simulated in a block-like pattern.

Therefore, the embodiments of the present application use the block pattern to calculate sparse attention. Through this method, the resources consumed in selecting an appropriate sparse pattern may be omitted. The block pattern is a method of dividing an input sequence into multiple blocks and performing sparse calculation among these blocks, which can reduce the calculation complexity and improve the efficiency. A core idea of this pattern is to utilize the sparsity of the attention mechanism, and only perform calculations among specific blocks, rather than performing full attention calculations across the entire sequence.

In some embodiments, the electronic device 110 may obtain a first parameter. The first parameter indicates a size and/or a number of candidate blocks, which for example may be a hyperparameter of the model. The electronic device 110 may then divide the first attention matrix into the plurality of candidate blocks based on the first parameter. Through this method, it may be avoided to load the entire first attention matrix into the high-bandwidth memory at one time, thus the number of reads and writes to the high-bandwidth memory is significantly reduced, improving the memory access efficiency. It is also possible to avoid explicitly storing the complete first attention matrix, thereby making the attention mechanism more efficient when processing long sequences.

In some embodiments, the electronic device 110 may sort the plurality of candidate blocks based on the weight information corresponding to the plurality of candidate blocks, and then determine the plurality of target blocks from the plurality of candidate blocks based on a sorting result of the plurality of candidate blocks. For example, the size of the first attention matrix is L×L, and the size of one candidate block is B×B. The attention mask may be defined as

$${M}_{s} ∈ {\{ 0 , 1 \}}^{\frac{L}{B} \times \frac{L}{B}} ,$$

where Mᵢⱼ=1 indicates that an element i pays attention to an element j, while Mᵢⱼ=0 indicates that an interaction of the element i with respect to the element j is ignored. An index set S of Mᵢⱼ=1 may be referred to as a sparse index set. For the convenience of expression, Mₛ may be expanded to

$$\tilde{{M}_{s}} ∈ {\{ 0 , 1 \}}^{L \times L} ,$$

and a masked attention matrix obtained after applying the attention mask to the first attention matrix may be represented by the following formula:

$${W}_{a t t n} ( \tilde{{M}_{s}} ) = {Softmax}_{safe} ( \frac{Q {K}^{T}}{\sqrt{d}} - c ( 1 - \tilde{{M}_{s}} ) ) - c ( 1 - \tilde{{M}_{s}} )$$

is a large negative bias, and c may be set to a sufficiently large number. It may be understood that a value of Mₛ may be 0 or 1, and accordingly, a value of

$$\tilde{{M}_{s}}$$

may also be 0 or 1. When the value of

$$\tilde{{M}_{s}}$$

is 0, a value in softmax is negative infinity, and the final calculated

$${W}_{a t t n} ( \tilde{{M}_{s}} ) is 0 ;$$

when the value of

$$\text{?}$$

is 0, the value in softmax is the weight value calculated according to the attention mechanism. Through this representation, the masked attention matrix may ignore unimportant parts.

In some embodiments, different masked attention matrices are obtained by applying different attention masks to the first attention matrix. For the sparse attention mechanism, it is expected to reduce the amount of computation on the premise of ensuring the accuracy of the result. Therefore, the smaller the difference between the first attention matrix and the masked attention matrix, the more accurate the application of the attention mask. Mathematically, the desired attention mask may also be obtained by constructing attention loss. For example, a concept Wₛᵤₘ₋ₐₜₜₙ representing a sum of weights of candidate blocks in the first attention matrix Wₐₜₜₙ may be defined, and a formula is expressed as follows:

$${W}_{sum - attn} = {\sum }_{i = 0}^{B - 1} {\sum }_{j = 0}^{B - 1} {W}_{a t t n} [ B \cdot p + i , B \cdot q + j ]$$

$$p , q ∈ \{ 0 , 1 , … , \frac{L}{B} - 1 \} , {W}_{sum - attn} ∈ {R}^{\frac{L}{B} \times \frac{L}{B}}$$

Then, given the sparsity, the sparse index set S may be expressed as follows:

$$\begin{matrix}S = {arg max}_{S} ‖ {W}_{a t t n} - {W}_{a t t n} ( \text{?} ) ‖ \\ = {arg max}_{S} ‖ {W}_{a t t n} ( \text{?} ) ‖ \\ = {arg max}_{S} ‖ {W}_{s u m - a t t n} ( {M}_{S} ) ‖ \\ = {arg max}_{k ∈ \{ 1 , … , ( 1 - sparsity ) {( \frac{L}{B} )}^{2} \}} ‖ {W}_{s u m - a t t n} ( k ) ‖\end{matrix}$$

Wₛᵤₘ₋ₐₜₜₙ may be calculated, and the optimal attention mask may be obtained by using the top-k operation. Through this method, the computational complexity may be reduced from O(L²d) to O((1−sparsity)L²d), thereby achieving a significant acceleration effect.

In some embodiments, there may be multiple methods of determining the target blocks from the plurality of candidate blocks based on the weight information corresponding to the plurality of candidate blocks. For example, the target mask may also be obtained by methods such as a fixed threshold or an adaptive threshold. The diffusion model needs to go through multiple denoising time steps, but the attention mask may be reused in other denoising time steps, which greatly reduces the amount of computation. The embodiments of the present application may use the top-k method to select k target blocks, so as to obtain more accurate data.

In an embodiment, the log-sum-exp (LSE) may be applied to the masked attention scores to ensure the numerical stability in the attention calculation process. The log-sum-exp (LSE) is a technique used for numerical stable calculation. A core objective of the LSE is to transform an exponential sum of a set of numbers into logarithmic domain, thereby avoiding the problem of numerical overflow or underflow that may occur in direct calculation.

In some embodiments, the electronic device 110 may determine the log-sum-exp (LSE) based on weight information of the plurality of target blocks in the first attention matrix, and generate reference weight information based on the log-sum-exp (LSE). For example, when calculating attention scores, the attention mask may be applied to ensure that only elements at positions of 1 in the attention mask participate in the calculation. Then, the LSE may stabilize the calculation by subtracting the maximum value of each row, thereby avoiding numerical problems in the exponential operation.

$$Z = \frac{Q {K}^{T}}{\sqrt{d}}$$

may be defined, and zⱼ is used to represent the jth component of a row vector Z. The formula for calculating the LSE may be as follows:

$$\begin{matrix}LSE ( z ) = log {\sum }_{j} exp ( {z}_{j} ) \\ = {max}_{j} {z}_{j} + log {\sum }_{j} exp ( {z}_{j} - {max}_{k} {z}_{k} )\end{matrix}$$

Through this method, it may be ensured that no numerical overflow or underflow occurs when calculating the softmax, and the softmax may be expressed as follows:

Softmax_{safe(z}_{ⱼ}₎=exp(zⱼ−LSE(z))

Then, the expression form of the numerically stable masked attention matrix is:

$${W}_{a t t n} = {Softmax}_{safe} ( \frac{Q {K}^{T}}{\sqrt{D}} )$$

After being obtained according to the LSE, the reference weight information may further be cached, so that the reference weight information may be directly used in subsequent steps.

In some embodiments, in the process of selecting the target blocks from the candidate blocks, the number of the selected target blocks is determined based on a second parameter, wherein the second parameter indicates a preset sparsity. The sparsity refers to a proportion or ratio of non-zero elements in data or a model, which for example may be a hyperparameter of the model. For example, the electronic device 110 may obtain the preset sparsity, and then determine a proportion of the target blocks in the candidate blocks based on the preset sparsity. Further, based on the weight information corresponding to the plurality of candidate blocks in the first attention matrix, the electronic device 110 may determine the target number of target blocks from the plurality of candidate blocks.

In some embodiments, for the multi-head attention mechanism, not all attention heads have the same sparse features. Some attention heads may perform well when less content is retained, while some attention heads may perform well when more content is retained. Therefore, it is unreasonable to reuse the same attention mask for all attention heads. Therefore, under the multi-head attention mechanism, the attention unit in the diffusion model includes a plurality of attention heads, and the plurality of attention heads correspond to independent attention masks. That is, under the multi-head attention mechanism, the attention mask corresponding to each attention head is calculated separately, rather than reusing or referring to other attention masks.

In some embodiments, since the recall rate may measure the extent to which sparsity can retain attention, the effectiveness of the sparse attention mechanism may also be evaluated by the recall rate. If the recall rate represents that the effect obtained by the sparse attention mechanism is not good, the overall effect of the model may be improved by adjusting the sparsity. The electronic device 110 may determine a first set of attention masks for the plurality of attention heads based on the preset sparsity, and then determine recall rate information corresponding to the plurality of attention heads based on the first set of attention masks, and then increase a first sparsity corresponding to a first attention head in the plurality of attention heads and reduce a second sparsity corresponding to a second attention head in the plurality of attention heads based on the recall rate information, where a first recall rate corresponding to the first attention head is higher than a second recall rate corresponding to the second attention head.

For example, since the attention mask corresponding to each attention head is calculated separately under the multi-head attention mechanism, these attention masks may form the first set of attention masks, and then the recall rate information corresponding to each attention head may be obtained respectively. The recall rate formula may be as follows:

$$Recall = \frac{{\sum }_{( i , j ) ∈ s p arse indices} {W}_{a t t n}^{( i , j )}}{{\sum }_{i , j} {W}_{a t t n}^{( i , j )}}$$

The higher the recall rate, the better the retention of the original attention scores. Then, the sparsity of the n attention heads with the highest recall rate may be increased to

$$\frac{1 + sparsity}{2} ,$$

and the sparsity of the n attention heads with the lowest recall rate may be reduced to

$$\frac{3 \times sparsity - 1}{2} .$$

Through this method, the redundancy among attention heads with a high recall rate may be effectively reduced, while the precision of attention heads with a low recall rate is improved, which not only reduces the waste of computing resources, but also improves the accuracy of the overall model.

In some embodiments, in the attention mechanism, the obtained attention weight matrix has an obvious boundary between the text modality and the pure video modality, showing different degrees of text sinking effects. Therefore, the electronic device 110 may determine a plurality of additional blocks associated with a text prompt from the plurality of candidate blocks in the first attention matrix, and then construct the attention mask based on the plurality of target blocks and the plurality of additional blocks.

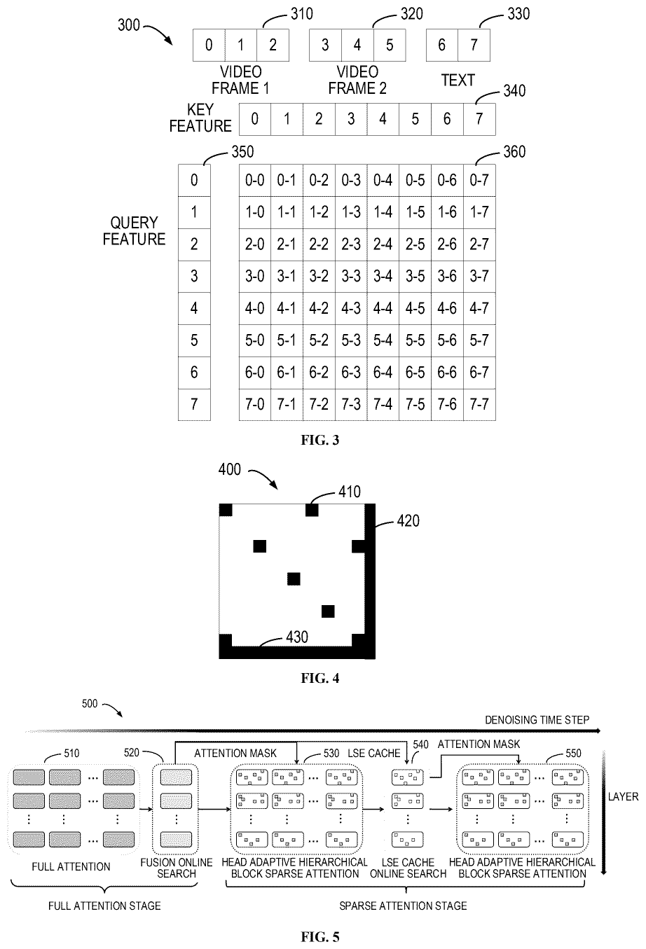

For example, if it is detected that the input content includes the text modality and the video modality, as shown in FIG. 4, a plurality of rectangular areas 410 in FIG. 4 represent the target blocks selected according to the block pattern, and then candidate blocks in a rectangular area 420 on the right side and a rectangular area 430 in the lower part of the figure are determined as the additional blocks, which may enhance the perception of the video modality to the text modality, thereby obtaining a better effect.

In some embodiments, in the attention mechanism, ensuring that each query feature pays attention to approximately the same number of key features may improve the coherence of the generated video, otherwise, some areas considered unimportant may never be paid attention to, thus generating artifacts. Therefore, uniform selection by row may be enforced in the block sparse pattern.

At block 204, the electronic device 110 may determine, using the attention unit and at the second denoising time step of the diffusion model, the second attention matrix of the second query feature and the second key feature based on the attention mask.

In an embodiment, when the same sparse manner is applied in the sparse attention mechanism, the value of obtained recall rate may be different for different attention heads, and may also be different for different transformer units in the diffusion model, but it does not change much with the change of the denoising time step. That is, the obtained attention mask may be reused in other denoising time steps.

For example, when the same attention mask is applied in the sparse attention mechanism, the value of recall rate obtained at the 10th denoising time step, the 0th layer, and the 6th attention head is close to that of the recall rate obtained at the 20th denoising time step, the 0th layer, and the 6th attention head; the value of recall rate obtained at the 10th denoising time step, the 0th layer, and the 6th attention head is different from that of the recall rate obtained at the 10th denoising time step, the 0th layer, and the 18th attention head; and the value of recall rate obtained at the 10th denoising time step, the 0th layer, and the 6th attention head is different from that of the recall rate obtained at the 10th denoising time step, the 15th layer, and the 6th attention head.

In some embodiments, in the first denoising time step of the diffusion model, the attention mask may be obtained through the determination of the target blocks. Then, in the second denoising time step of the diffusion model, the attention mask obtained in the first denoising time step may continue to be applied, thereby omitting the process of re-obtaining the attention mask, and greatly improving the efficiency of the overall model. Moreover, since the recall rate obtained by applying the same attention mask in different denoising time steps is basically the same, the overall model effect is not affected.

In some embodiments, when the same LSE is applied in the sparse attention mechanism, the value of the obtained recall rate may be different for different attention heads or different network levels, but it does not change much with the change of the denoising time step. That is, the obtained LSE may be reused in other denoising time steps. For example, the electronic device 110 may determine a second initial matrix of the second query feature and the second key feature using the attention unit at the second denoising time step of the diffusion model, and then reuse the reference weight information to perform data stabilization processing on the second initial matrix to obtain an optimized matrix, and then reuse the attention mask on the optimized matrix to obtain the second attention matrix.

For example, in the first denoising time step of the diffusion model, the reference weight information has been obtained through calculation, then in the second denoising time step of the diffusion model, the reference weight information obtained in the first denoising time step may continue to be applied, thereby omitting the process of re-obtaining the reference weight information, and greatly reducing the additional search time. Moreover, since the recall rate obtained by applying the same LSE in different denoising time steps is basically the same, accurate search may also be ensured.

At block 250, the electronic device 110 generates target content corresponding to the input content at least based on the second attention matrix.

In some embodiments, when the same attention mask is applied in the sparse attention mechanism, the value of obtained recall rate may changes a little with the change of the denoising time step. Therefore, the attention mask may be recalculated after several denoising time steps to ensure the overall accuracy. For example, the electronic device 110 may determine a second attention mask at a third denoising time step of the diffusion model, and then determine, using the attention unit and at a fourth denoising time step of the diffusion model, a third attention matrix of a third query feature and a third key feature based on the second attention mask, for generating the target content.

For example, it may be predetermined that the attention mask is re-obtained at the 10th denoising time step, i.e., the third denoising time step. Then, when the 10th denoising time step is executed, the step of determining the attention matrix of the query feature and the key feature using the attention unit is re-executed. Then the plurality of target blocks are determined from the plurality of candidate blocks based on the weight information corresponding to the plurality of candidate blocks in the attention matrix, and a new second attention mask is re-generated according to the target blocks. Then, in the fourth denoising time step after the 10th denoising time step, the second attention mask is reused to obtain the third attention matrix of the third query feature and the third key feature, and then the obtained third attention matrix is continuously used for information processing in subsequent denoising time steps, and finally the target content is obtained.

In some embodiments, when the same reference weight information is applied in the sparse attention mechanism, the change in the value of the obtained recall rate due to the change of the denoising time step is too small, so the same reference weight information may be reused in all denoising time steps, which greatly improves the efficiency on the premise of ensuring the accuracy. The electronic device 110 may obtain the cached reference weight information, and then determine the second attention mask based on the cached reference weight information at the third denoising time step of the diffusion model.

For example, the cached reference weight information may be obtained, wherein the reference weight information is determined based on the first attention matrix. Then, the reference weight information is reused in the denoising time step after the first denoising time step to obtain the attention mask.

In some embodiments, FIG. 5 shows a structural flowchart of information processing through the diffusion model. The denoising time step T_{w}={1, 2, . . . , t_{w}} in the full attention stage may be defined, and k denoising time steps

$${T}_{s} = \{ {t}_{s}^{1} , {t}_{s}^{2} , … , {t}_{s}^{k} \}$$

are selected to perform accurate online search, and

$${t}_{key}^{1} = {t}_{w} .$$

The full attention mechanism 510 is adopted from the denoising time step 1 to the denoising time step t_{w}−1. At the denoising time step t_{w}, the fusion online search 520 is applied to perform full attention calculation, thereby generating the first attention mask, which may then be passed to the subsequent denoising time steps

$${t}_{key}^{1} + 1 , {t}_{key}^{1} + 2 , … , {t}_{key}^{2} - 1$$

to perform the calculation of the head adaptive hierarchical block sparse attention 530. Subsequently, for each

$${t}_{key}^{i} , i > 1 ,$$

the LSE cache online search 540 may be performed using the cache LSE searched in the previous

$${t}_{key}^{1} ,$$

to obtain the second attention mask, which is then passed to the subsequent denoising time steps

$${t}_{key}^{i} , {t}_{key}^{i} + 1 , … , {t}_{key}^{i + 1} - 1 ,$$

to complete the calculation of the head adaptive hierarchical block sparse attention 550.

In some embodiments, since the technical solution of the present application has a better effect when applied to input content including a video, the information processing method may be applied to input content including a video.

In some embodiments, a plug-and-play plugin may also be provided, which may be seamlessly integrated into the DiT without fine-tuning or data profiling, and it is independent of other acceleration technologies such as parallelization, cache reuse, and token merging.

The combination of the head adaptive hierarchical block sparse attention and the online search technology significantly reduces the latency while maintaining high-quality result generation. In addition, because no extra fine-tuning or analysis dependent on datasets is required, a plug-and-play plugin may be provided, which may be seamlessly integrated into existing diffusion models.

### Example Apparatus and Device

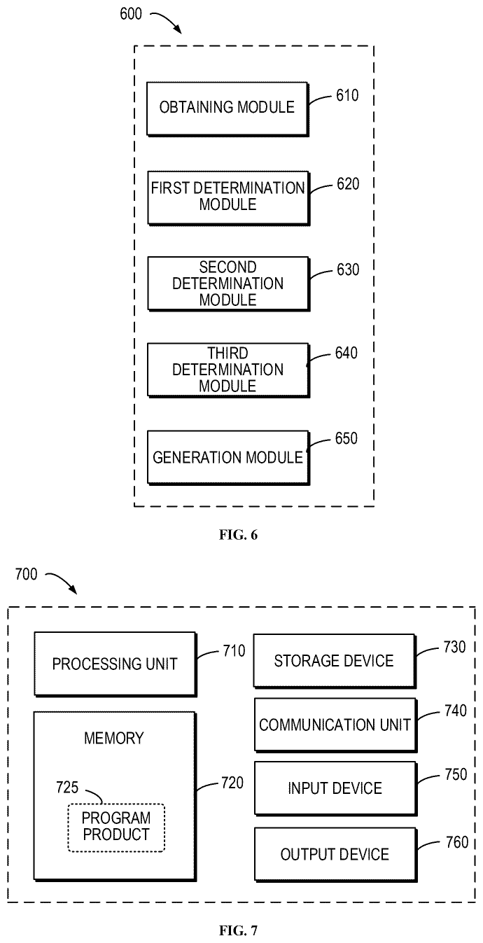

The embodiments of the present disclosure further provide corresponding apparatuses for implementing the above methods or processes. FIG. 6 is a schematic structural block diagram of an apparatus 600 for information processing according to some embodiments of the present disclosure. The apparatus 600 may be implemented as or included in the electronic device 110 as discussed above. Each module/component in the apparatus 600 may be implemented by hardware, software, firmware, or any combination thereof.

As shown in FIG. 6, the apparatus 600 includes an obtaining module 610 configured to obtain input content of a diffusion model, the diffusion model including a transformer unit, and the transformer unit including an attention unit; a first determination module 620 configured to determine, using the attention unit and at a first denoising time step of the diffusion model, a first attention matrix of a first query feature and a first key feature, the first attention matrix corresponding to full attention; a second determination module 630 configured to determine, based on weight information corresponding to a plurality of candidate blocks in the first attention matrix, a plurality of target blocks from the plurality of candidate blocks; a third determination module 640 configured to determine, using the attention unit and at a second denoising time step of the diffusion model, a second attention matrix of a second query feature and a second key feature based on an attention mask, the attention mask being determined based on the plurality of target blocks; and a generation module 650 configured to generate target content corresponding to the input content at least based on the second attention matrix.

In some embodiments, the information processing apparatus 600 further includes a fourth determination module 640 configured to determine a second attention mask at a third denoising time step of the diffusion model; and a fifth determination module 650 configured to determine, using the attention unit and at a fourth denoising time step of the diffusion model, a third attention matrix of a third query feature and a third key feature based on the second attention mask, for generating the target content.

In some embodiments, the fourth determination module 640 is further configured to obtain cached reference weight information, the reference weight information being determined based on the first attention matrix; and determine the second attention mask based on the cached reference weight information at the third denoising time step of the diffusion model.

In some embodiments, the reference weight information includes a log-sum-exp, LSE, determined based on weight information of the plurality of target blocks in the first attention matrix.

In some embodiments, the attention mask indicates that the plurality of target blocks in the plurality of candidate blocks is retained to perform an attention operation.

In some embodiments, the second determination module 630 is further configured to sort the plurality of candidate blocks based on the weight information corresponding to the plurality of candidate blocks; and determine the plurality of target blocks from the plurality of candidate blocks based on a sorting result of the plurality of candidate blocks.

In some embodiments, the information processing apparatus 600 is further configured to obtain a first parameter, the first parameter indicating a number and/or a size of the candidate blocks; and divide the first attention matrix into the plurality of candidate blocks based on the first parameter.

In some embodiments, the number of the plurality of target blocks is determined based on a second parameter which indicates a preset sparsity.

In some embodiments, the attention unit includes a plurality of attention heads, and the plurality of attention heads correspond to independent attention masks.

In some embodiments, the information processing apparatus 600 is further configured to determine a first set of attention masks for the plurality of attention heads based on the preset sparsity; determine recall rate information corresponding to the plurality of attention heads based on the first set of attention masks; and increase a first sparsity corresponding to a first attention head in the plurality of attention heads and reduce a second sparsity corresponding to a second attention head in the plurality of attention heads based on the recall rate information, where a first recall rate corresponding to the first attention head is higher than a second recall rate corresponding to the second attention head.

In some embodiments, the information processing apparatus 600 is further configured to determine a plurality of additional blocks associated with a text prompt from the plurality of candidate blocks in the first attention matrix; and construct the attention mask based on the plurality of target blocks and the plurality of candidate blocks.

In some embodiments, the target content includes video content generated by the diffusion model.

In some embodiments, the diffusion model includes a plurality of transformer units, and attention units in different transformer units correspond to independent attention masks.

The units included in the apparatus 600 may be implemented in various ways, including software, hardware, firmware, or any combination thereof. In some embodiments, one or more units may be implemented using software and/or firmware, for example machine executable instructions stored on a storage medium. In addition to machine executable instructions or as an alternative, some or all units in the apparatus 600 may be implemented at least partially by one or more hardware logic components. As an example, rather than a limitation, example types of hardware logic components that may be used include field programmable gate arrays (FPGAs), application specific integrated circuits (ASICs), application specific standard products (ASSPs), system-on-chips (SOCs), complex programmable logic devices (CPLDs), etc.

FIG. 7 is a block diagram of an electronic device 700 in which one or more embodiments of the present disclosure may be implemented. It should be understood that the electronic device 700 shown in FIG. 7 is only illustrative, without suggesting any limitation on the functions and scope of the embodiments described herein. The electronic device 700 shown in FIG. 7 may be used to implement the electronic device 110 shown in FIG. 1.

As shown in FIG. 7, the electronic device 700 is in a form of a general electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and may perform various processes based on a program stored in the memory 720. In a multi-processor system, multiple processing units execute computer executable instructions in parallel, to improve the parallel processing capability of the electronic device 700.

The electronic device 700 typically includes multiple computer storage medium. Such medium may be any available medium accessible by the electronic device 700, including, but not limited to, volatile and non-volatile medium, and removable and non-removable medium. The memory 720 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 730 may be any removable or non-removable medium, and may include a machine-readable medium such as a flash drive, a disk, or any other medium, which may be used to store data and/or information (such as training data for training) and may be accessed within the electronic device 700.

The electronic device 700 may further include additional removable/non-removable, volatile/non-volatile memory medium. Although not shown in FIG. 7, a disk driver for reading from or writing into removable and non-volatile disks (such as a “floppy disk”), and an optical disk driver for reading from or writing into removable and non-volatile optical disks may be provided. In these cases, each driver may be connected to a bus (not shown) by one or more data medium interfaces. The memory 720 may include a computer program product 725, which has one or more program modules configured to perform various methods or acts of various embodiments of the present disclosure.

The communication unit 740 implements communication with other electronic devices through a communication medium. In addition, the functions of the components of the electronic device 700 may be implemented by a single computing cluster or multiple computing machines, which may communicate through communication connections. Therefore, the electronic device 700 may use a logical connection with one or more other servers, a network personal computer (PC) or another network node to operate in a networked environment.

The input device 750 may be one or more input devices, such as a mouse, a keyboard, a tracking ball, etc. The output device 760 may be one or more output devices, such as a display, a speaker, a printer, etc. The electronic device 700 may also communicate with one or more external devices (not shown) through the communication unit 740 as needed, the external devices such as a storage device, a display device, etc., communicate with one or more devices that enable a user to interact with the electronic device 700, or communicate with any devices (such as a network card, a modem, etc.) that enable the electronic device 700 to communicate with one or more other electronic devices. Such communication may be performed via input/output (I/O) interfaces (not shown).

According to an example implementation of the present disclosure, a computer-readable storage medium is provided, which has computer executable instructions stored thereon, where the computer executable instructions are executed by a processor to implement the method described above. According to an example implementation of the present disclosure, a computer program product is further provided, the computer program product is tangibly stored on a non-transitory computer-readable medium and includes computer executable instructions, and the computer executable instructions are executed by a processor to implement the method described above.

Various aspects of the present disclosure are described herein with reference to the flowcharts and/or block diagrams of the method, the apparatus, the device, and the computer program product implemented according to the present disclosure. It should be understood that each block of the flowchart and/or block diagram, and a combination of each block in the flowchart and/or block diagram may be implemented by computer-readable program instructions.

These computer-readable program instructions may be provided to a processing unit of a general-purpose computer, a special-purpose computer, or other programmable information processing apparatus, to produce a machine, so that these instructions, when executed by the processing unit of the computer or other programmable information processing apparatus, produce an apparatus for implementing a function/act specified in one or more blocks of the flowchart and/or block diagram. These computer-readable program instructions may also be stored in a computer-readable storage medium, these instructions make the computer, the programmable information processing apparatus, and/or other devices work in a specific manner, and thus, the computer-readable medium storing the instructions includes a manufactured product, which includes instructions for implementing various aspects of the function/act specified in one or more blocks of the flowchart and/or block diagram.

The computer-readable program instructions may be loaded onto a computer, another programmable information processing apparatus, or other devices, to perform a series of operations and steps on the computer, the other programmable information processing apparatus, or the other devices, so as to generate a computer-implemented process, so that the instructions executed on the computer, the other programmable information processing apparatus, or the other devices implement the function/act specified in one or more blocks of the flowchart and/or block diagram.

The flowchart and block diagram in the drawings show the possibly implemented architectures, functions, and operations of the system, the method, and the computer program product according to multiple implementations of the present disclosure. In this regard, each block in the flowchart or block diagram may represent a module, a program segment, or a part of instructions, and the module, the program segment, or the part of instructions contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a dedicated hardware-based system that executes specified functions or acts, or may be implemented by a combination of dedicated hardware and computer instructions.

The implementations of the present disclosure have been described above, and the above description is exemplary, non-exhaustive, and not limited to the disclosed implementations. Without departing from the scope and spirit of the illustrated implementations, many modifications and changes will be apparent to those of ordinary skill in the art. The terms used herein are selected to best explain the principles, practical applications, or improvements to the technology in the market of the implementations, or to enable other persons skilled in the art to understand the implementations disclosed herein.

1. A method of information processing, comprising:
obtaining input content of a diffusion model, the diffusion model comprising a transformer unit, the transformer unit comprising an attention unit;
determining, using the attention unit and at a first denoising time step of the diffusion model, a first attention matrix of a first query feature and a first key feature, the first attention matrix corresponding to full attention;
determining, based on weight information corresponding to a plurality of candidate blocks in the first attention matrix, a plurality of target blocks from the plurality of candidate blocks;
determining, using the attention unit and at a second denoising time step of the diffusion model, a second attention matrix of a second query feature and a second key feature based on an attention mask, the attention mask being determined based on the plurality of target blocks; and
generating target content corresponding to the input content at least based on the second attention matrix.

2. The method of claim 1, wherein the attention mask is a first attention mask, and before generating the target content corresponding to the input content, the method further comprises:
determining a second attention mask at a third denoising time step of the diffusion model; and
determining, using the attention unit and at a fourth denoising time step of the diffusion model, a third attention matrix of a third query feature and a third key feature based on the second attention mask, for generating the target content.

3. The method of claim 2, wherein determining the second attention mask at the third denoising time step of the diffusion model comprises:
obtaining cached reference weight information, the reference weight information being determined based on the first attention matrix; and
determining the second attention mask based on the cached reference weight information at the third denoising time step of the diffusion model.

4. The method of claim 3, wherein the reference weight information comprises a log-sum-exp, LSE, determined based on weight information of the plurality of target blocks in the first attention matrix.

5. The method of claim 1, wherein the attention mask indicates that the plurality of target blocks in the plurality of candidate blocks is retained to perform an attention operation.

6. The method of claim 1, wherein determining, based on the weight information corresponding to the plurality of candidate blocks in the first attention matrix, the plurality of target blocks from the plurality of candidate blocks comprises:
sorting the plurality of candidate blocks based on the weight information corresponding to the plurality of candidate blocks; and
determining the plurality of target blocks from the plurality of candidate blocks based on a sorting result of the plurality of candidate blocks.

7. The method of claim 1, further comprising:
obtaining a first parameter, the first parameter indicating a number and/or a size of candidate blocks; and
dividing the first attention matrix into the plurality of candidate blocks based on the first parameter.

8. The method of claim 1, wherein the number of the plurality of target blocks is determined based on a second parameter which indicates a preset sparsity.

9. The method of claim 1, wherein the attention unit comprises a plurality of attention heads, and the plurality of attention heads correspond to independent attention masks.

10. The method of claim 9, further comprising:
determining a first set of attention masks for the plurality of attention heads based on a preset sparsity;
determining recall rate information corresponding to the plurality of attention heads based on the first set of attention masks; and
increasing a first sparsity corresponding to a first attention head in the plurality of attention heads and reducing a second sparsity corresponding to a second attention head in the plurality of attention heads based on the recall rate information, wherein a first recall rate corresponding to the first attention head is higher than a second recall rate corresponding to the second attention head.

11. The method of claim 1, wherein the input content comprises a text prompt, and the method further comprises:
determining a plurality of additional blocks associated with the text prompt from the plurality of candidate blocks in the first attention matrix; and
constructing the attention mask based on the plurality of target blocks and the plurality of additional blocks.

12. The method of claim 1, wherein the target content comprises video content generated by the diffusion model.

13. The method of claim 1, wherein the diffusion model comprises a plurality of the transformer units, and attention units in different transformer units correspond to independent attention masks.

14. An electronic device, comprising:
at least one processor; and
at least one memory coupled to the at least one processor and storing instructions executable by the at least one processor, the instructions, when executed by the at least one processor, causing the electronic device to perform acts comprising:
obtaining input content of a diffusion model, the diffusion model comprising a transformer unit, the transformer unit comprising an attention unit;
determining, using the attention unit and at a first denoising time step of the diffusion model, a first attention matrix of a first query feature and a first key feature, the first attention matrix corresponding to full attention;
determining, based on weight information corresponding to a plurality of candidate blocks in the first attention matrix, a plurality of target blocks from the plurality of candidate blocks;
determining, using the attention unit and at a second denoising time step of the diffusion model, a second attention matrix of a second query feature and a second key feature based on an attention mask, the attention mask being determined based on the plurality of target blocks; and
generating target content corresponding to the input content at least based on the second attention matrix.

15. The electronic device of claim 14, wherein the attention mask is a first attention mask, and before generating the target content corresponding to the input content, the acts further comprise:
determining a second attention mask at a third denoising time step of the diffusion model; and
determining, using the attention unit and at a fourth denoising time step of the diffusion model, a third attention matrix of a third query feature and a third key feature based on the second attention mask, for generating the target content.

16. The electronic device of claim 15, wherein determining the second attention mask at the third denoising time step of the diffusion model comprises:
obtaining cached reference weight information, the reference weight information being determined based on the first attention matrix; and
determining the second attention mask based on the cached reference weight information at the third denoising time step of the diffusion model.

17. The electronic device of claim 16, wherein the reference weight information comprises a log-sum-exp, LSE, determined based on weight information of the plurality of target blocks in the first attention matrix.

18. The electronic device of claim 14, wherein the attention mask indicates that the plurality of target blocks in the plurality of candidate blocks is retained to perform an attention operation.

19. The electronic device of claim 14, wherein determining, based on the weight information corresponding to the plurality of candidate blocks in the first attention matrix, the plurality of target blocks from the plurality of candidate blocks comprises:
sorting the plurality of candidate blocks based on the weight information corresponding to the plurality of candidate blocks; and
determining the plurality of target blocks from the plurality of candidate blocks based on a sorting result of the plurality of candidate blocks.

20. A non-transitory computer-readable storage medium having a computer program stored thereon, the computer program, when executed by a processor, implementing a method comprising:
obtaining input content of a diffusion model, the diffusion model comprising a transformer unit, the transformer unit comprising an attention unit;
determining, using the attention unit and at a first denoising time step of the diffusion model, a first attention matrix of a first query feature and a first key feature, the first attention matrix corresponding to full attention;
determining, based on weight information corresponding to a plurality of candidate blocks in the first attention matrix, a plurality of target blocks from the plurality of candidate blocks;
determining, using the attention unit and at a second denoising time step of the diffusion model, a second attention matrix of a second query feature and a second key feature based on an attention mask, the attention mask being determined based on the plurality of target blocks; and
generating target content corresponding to the input content at least based on the second attention matrix.
